(19) United States
(12) Patent Application Publication
(10) Pub. No.: US 2026/0348194 A1
(43) Pub. Date: Nov. 5, 2026

(54) CYLINDER LOCK

(71) Applicant: ABUS August Bremicker Söhne KG, Wetter-Volmarstein (DE)

(72) Inventors: Ernst Pankratius, Wetter (DE); Kenneth Wong Ka Fai, Kaiping (CN)

(21) Appl. No.: 19/654,751

(22) Filed: Apr. 22, 2026

(30) Foreign Application Priority Data
Apr. 30, 2025 (DE) 10 2025 116 752.4

(51) Int. Cl. E05B 29/00

(52) U.S. Cl. CPC E05B 29/0053; E05B 29/0033

(57) ABSTRACT

A cylinder lock comprises a cylinder housing and a cylinder core that has a core housing having a plurality of disk tumblers and having a latch element. The latch element is movable between a release position and a blocking position and engages into a blocking recess of the cylinder housing in the blocking position. The plurality of disk tumblers are configured to block the latch element against a movement into the release position or to release said latch element for the release position. The latch element is preloaded into the release position and the cylinder lock further comprises a deflection device in order, when the latch element is positioned in the blocking position, to deflect a rotational force that is exerted on a rotation of the cylinder core in the opening direction of rotation into a radially outwardly acting force.

### CROSS-REFERENCE TO RELATED APPLICATIONS

This application claims priority to German Patent Application No. DE 10 2025 116 752.4, filed Apr. 30, 2025, the entire content of which is hereby incorporated by reference in its entirety.

### FIELD

The invention relates to a cylinder lock that comprises a cylinder housing and a cylinder core extending along a cylinder axis. The cylinder core is rotatably received in the cylinder housing about the cylinder axis and may be rotated by an associated key along an opening direction of rotation from a closed position into an open position, wherein the cylinder core has a core housing in which a plurality of disk tumblers and a latch element are received. The latch element is moveable between a release position and a blocking position, wherein, in the blocking position, the latch element projects radially out of the core housing with respect to the cylinder axis and engages into a blocking recess of the cylinder housing, and wherein a rotation of the cylinder core from the closed position into the open position is blocked by the engagement of the blocking element into the blocking recess. In the release position, the latch element is moved out of the blocking recess and releases the rotation of the cylinder core into the open position. Furthermore, the plurality of disk tumblers may be moved between a respective locking position and a respective unlocking position and are configured to block the latch element in the locking position against a movement into the release position and to release said latch element in the unlocking position for the movement into the release position.

### BACKGROUND

Such cylinder locks may be used in a variety of applications and may, for instance, serve to selectively block doors, windows or flaps or release them for an opening. For this purpose, the cylinder lock may, for example, be attached to a door leaf of a door, wherein a latch may be drivable by rotating the cylinder core into the open position in order to release a movement of the door leaf relative to a frame of the door. On the other hand, due to the coupling of the latch with the cylinder core, the latch may also be blocked in a blocking position when the cylinder core is blocked against a rotation into the open position in order to prevent a movement of the door leaf relative to the frame.

The blocking of the cylinder core, and thus the locking of the cylinder lock, in this respect takes place by at least one of the plurality of disk tumblers assuming a locking position and, as a result, keeping the aforementioned latch element in engagement with a blocking recess of the cylinder housing if a correctly coded key associated with the cylinder lock is not introduced into a keyway of the cylinder core. If, on the other hand, the associated key is introduced into the cylinder core, all the disk tumblers are sorted into a respective unlocking position and the latch element is thereby released for a movement into the release position so that the cylinder core may be transferred to the open position by turning the key and the cylinder lock may be opened.

The plurality of disk tumblers therefore in particular serve to define a coding of the cylinder lock in order to secure the cylinder lock against unauthorized opening processes. However, there is a problem with cylinder locks of this kind in manipulation attempts that are based on the so-called lock picking. In such manipulation attempts, special opening tools are used with which the disk tumblers may be displaced from their respective locking position up to and into their respective unlocking position, while a torque is simultaneously exerted on the cylinder core by a rotational force acting in the opening direction of rotation. According to one method ("setting" of the disk tumblers), the disk tumblers, which in the locking position may in particular likewise project out of the core housing and engage into respective disk tumbler blocking recesses, are successively displaced into the respective unlocking position so that ultimately all the disk tumblers get stuck at an edge of the respective disk tumbler blocking recess of the core housing and the cylinder core may be rotated further in the opening direction of rotation up to and into the open position. According to another method ("probing" of the codings), the respective unlocking positions are identified by a changed resistance on the displacement of the disk tumblers into the unlocking direction, wherein the changed resistance may be manually probed by way of a suitable tool and/or may be acoustically recognized. Due to the thus determined displacement paths which the disk tumblers cover between the respective locking position and the respective unlocking position, a correspondingly coded key may be copied that may then be capable of opening the cylinder lock without damage.

### SUMMARY

In view of this, it is an object of the invention to provide a cylinder lock of the kind explained above that offers improved protection against manipulation attempts.

This object is satisfied by a cylinder lock having the features of claim 1.

In this cylinder lock, the latch element is preloaded into the release position and the cylinder lock further comprises a deflection device that is configured to deflect a rotational force that acts on the latch element, which assumes the blocking position, on a rotation of the cylinder core in the opening direction of rotation into a radially outwardly acting force.

In this respect, the rotational force to be deflected in particular refers to a force that results in a torque acting on the latch element so that the rotational force may be oriented tangentially to a circular path along which the cylinder core moves on a rotation into the open position. Furthermore, the rotational force may thus be perpendicular to the radial direction in which the rotational force is deflected by the deflection device. The deflection device may in particular be configured to deflect the rotational force proportionally into a force component acting radially outwardly and a component acting in the direction of the rotational force.

As initially already explained, both methods of lock picking mentioned ("setting" the disk tumblers and "probing" the coding) require a torque to be exerted on the cylinder core in the opening direction of rotation. If the latch element assumes the blocking position and engages into the blocking recess, the latch element abuts a boundary of the blocking recess upon application of such a torque and thus transmits a rotational force to the cylinder housing, wherein the rotational force and the torque may be absorbed by the cylinder housing and a rotation of the cylinder core into the open position is blocked. Since the cylinder lock disclosed herein now comprises the aforementioned deflection device, this rotational force, which is necessarily applied during lock picking attempts to generate a torque, may not only be compensated or balanced, but to a certain extent may even be used to secure the latch element in the blocking recess and may thus counteract both mentioned methods of lock picking.

This concept is initially based on the fact that the latch element is preloaded into the release position and not – as is often the case with other known cylinder locks – into the blocking position. It may thereby be achieved that it is not necessary to displace the latch element, which is properly released for a movement into the release position, into the release position by a contact with the cylinder housing during a rotation of the cylinder core into the open position. While such known cylinder locks with latch elements preloaded into the blocking position ultimately require a deflection device for deflecting a rotational force into a force directed radially inwardly and out of the blocking recess on the latch element, the latch element of the cylinder lock disclosed herein may, after a sorting of the disk tumblers into the unlocking position, due to the preloading into the release position, immediately assume the release position and be moved out of the blocking recess so that the cylinder core may be rotated into the open position. A conventional deflection of a rotational force radially inwards is thus no longer necessary.

The aforementioned deflection device may then be realized on the basis of this preloading of the latch element in order to ultimately be able to effectively counteract both methods of lock picking:

Since a rotational force acting on the latch element in the opening direction of rotation may be deflected into a radially outwardly acting force by the deflection device, when the latch element assumes the blocking position, the latch element may be urged into the blocking recess or secured therein upon application of a torque to the cylinder core so that a further rotation of the cylinder core in the opening direction of rotation is blocked. Even if, during an attempt to set the disk tumblers, all the disk tumblers are therefore successfully moved into the respective unlocking position and may, for instance, be positioned at a respective edge of an associated disk tumbler blocking recess, the cylinder core cannot be rotated any further in the opening direction of rotation due to the latch element still being urged into the blocking recess by the deflected rotational force so that the cylinder core remains blocked in the closed position. If, on the other hand, the torque is then released in the opening direction of rotation in order to also cancel the deflection of the rotational force into a force acting radially outwardly on the latch element, the blocking of the disk tumblers at the edge of a disk tumbler blocking recess cannot be maintained so that the disk tumblers may return to the locking position and the cylinder core is thus fully secured again.

The further method of probing the codings furthermore requires identifying a changing resistance when displacing the disk tumblers. However, this resistance may in particular be based on a contact of the latch element with a structure of the disk tumbler so that it may ultimately be felt when the disk tumblers release the latch element for the release position and thus assume the unlocking position. For example, at the disk tumblers, latch receiving recesses may be provided, in which the latch element may be arranged when the disk tumblers are positioned in the unlocking position, wherein, for the probing of the coding, the abutment of the latch element at edges of such a latch receiving recess may, for instance, be detected. Since, in the cylinder lock disclosed herein, the aforementioned rotational force may, however, be deflected into a force acting radially outwardly on the latch element, the contact between the latch element and the disk tumblers that is required for probing the codings may be reduced or even cancelled if the latch element (in corresponding embodiments, as explained in more detail below) is urged even further radially outwardly due to the deflected rotational force and a contact with the disk tumblers is released. A probing of the codings may therefore also be made more difficult or even completely prevented.

In general, the opening direction of rotation may be clockwise or counterclockwise.

Furthermore, the cylinder core may generally have a keyway which in particular extends along the cylinder axis and into which the associated key may be introduced through a key introduction opening formed at one end face of the cylinder core.

In the context of the present disclosure, the designations radial and axial are further generally to be understood as referring to the cylinder axis, unless another reference axis is explicitly specified.

Further embodiments are explained in the dependent claims, in the description, and with reference to the drawings.

In some embodiments, the disk tumblers may have respective sorting sections, wherein the disk tumblers may be movable from the locking position into the unlocking position by a cooperation of the sorting sections with a sorting structure of the associated key. For example, the sorting sections may project into the aforementioned keyway and the sorting structure of the associated key may, for example, be formed by a sorting passage which is formed at a key shaft of the associated key and whose boundaries may cooperate with the sorting sections in order to sort the disk tumblers into the respective unlocking position.

In some embodiments, the latch element may be blockable against a movement out of the blocking recess by the deflection of the rotational force. In particular, it may thus be preventable by the deflection device that the latch element positioned in the blocking position moves out of the blocking recess when a torque is present in the opening direction of rotation so that the cylinder core may be reliably secured against a rotation into the open position unless the associated key is introduced into the cylinder core. Due to the deflection of the rotational force, at least one radially outwardly acting force that compensates for the preloading of the latch element into the release position may thus be applied to the latch element.

In some embodiments, the latch element may, starting from the blocking position, be able to be urged further radially outwardly into a decoupling position by the deflection of the rotational force.

In particular, the latch element assuming the blocking position may thus, upon application of a torque to the cylinder core in the opening direction of rotation, be movable radially outwardly by the rotational force deflected by the deflection device, whereby the latch element may in particular move away from the disk tumblers and/or may release a contact with the disk tumblers. As already explained above, the aforementioned methods of lock picking may hereby no longer be used since, also after a setting of the disk tumblers, the latch element blocks a further rotation of the opening direction of rotation by an engagement into the blocking recess and a probing of the codes by detecting a contact between the latch element and the disk tumblers is not possible due to the latch element that has moved away from the disk tumblers.

In particular, in such embodiments it may be provided that the latch element may, starting from the blocking position, be moved at least partly and/or sectionally further radially outwardly by the deflection of the rotational force. For example, it may generally be provided that the latch element may be pivoted between the release position and the blocking position, wherein, in such embodiments, due to the deflection of the rotational force, in particular a pivoting of the latch element may take place, by which a section of the latch element that is opposite a pivot axle may be movable radially outwardly, while the pivot axle may remain unmoved. In the case of linearly movable latch elements, the latch element may, however, be movable radially outwardly overall by the deflected rotational force.

Furthermore, in such embodiments with the latch element movable from the blocking position into the decoupling position, the latch element may be spaced apart from a (radially outwardly disposed) base of the blocking recess in the blocking position so that a free space exists to be able to bring the latch element further radially outwardly into the decoupling position by deflecting the rotational force.

In some embodiments, the latch element may contact the disk tumblers in the blocking position and the latch element may be spaced apart from the disk tumblers in the decoupling position. Thus, the latch element may be displaceable radially outwardly due to the deflection of the rotational force in order to be moved away from the disk tumblers and to prevent the methods of lock picking explained above.

In some embodiments, the latch element may be arranged within the core housing in the release position. In particular, the core housing may have a substantially cylindrical core housing section and the cylinder housing may comprise a core receiving section that is likewise substantially cylindrical so that the cylinder core may be rotatable along a lateral surface of the core receiving section when the latch element is arranged in the release position and thus within the core housing. However, in the blocking position, the latch element may project radially out of the core housing section to be able to engage into the blocking recess formed as a recess or a cut in the core receiving section and, as a result, to be able to secure the cylinder core against a rotation relative to the cylinder housing.

In some embodiments, the latch element may have a latch element deflection surface facing in the opening direction of rotation and the blocking recess may have a blocking recess deflection surface facing the latch element deflection surface, wherein the rotational force may be deflectable by a cooperation of the latch element deflection surface and the blocking recess deflection surface.

In such embodiments, the deflection device may therefore in particular comprise the latch element deflection surface and the blocking recess deflection surface. The blocking recess deflection surface may in particular form a boundary of the blocking recess in the opening direction of rotation.

Furthermore, in some embodiments, the cylinder core may be arranged with a rotational clearance in the cylinder housing, wherein the latch element deflection surface and the blocking recess deflection surface may be spaced apart from one another in the closed position of the cylinder core and may be able to be brought into contact with one another by overcoming the rotational clearance on a rotation of the cylinder core in the opening direction of rotation to be able to deflect the rotational force. Alternatively thereto, in some embodiments, the latch element deflection surface and the blocking recess deflection surface may, however, contact one another in the closed position of the cylinder core.

In some embodiments, it may be provided that the force may be applied to the latch element in the radial direction by moving the latch element deflection surface along the blocking recess deflection surface when the rotational force is applied in the opening direction of rotation; or that the latch element may be blocked against a radially inward movement by a contact between the latch element deflection surface and the blocking recess deflection surface upon application of the rotational force.

Said deflection surfaces (latch element deflection surface and blocking recess deflection surface) may further in particular be designed as planar and/or aligned parallel to one another when the latch element deflection surface and the blocking recess deflection surface are in contact with one another.

In some embodiments, the latch element deflection surface and the blocking recess deflection surface may be oriented inclined to the opening direction of rotation. In such embodiments, the latch element deflection surface may in particular be formed as a surface so-to-say overhanging in the opening direction at the latch element and the blocking element deflection surface may form a run-on surface for the latch element deflection surface. Therefore, in such embodiments, in the course of a rotation of the cylinder core in the opening direction of rotation (when the associated key is not introduced into the cylinder core), the latch element deflection surface may run onto the blocking element deflection surface that may thereby urge the latch element radially outwardly in the manner of a wedge.

Furthermore, an inclined orientation of the blocking element deflection surface and the latch element deflection surface may also result in the latch element being blocked against a movement into the release position when the two surfaces mentioned contact one another since the blocking element deflection surface stands in the way of the latch element deflection surface and thus the latch element on a radially inward movement. In order therefore to enable a movement of the latch element into the release position, the contact between said deflection surfaces must first be released and the cylinder core must, for instance, be rotated back a little opposite the opening direction of rotation, whereby the torque applied to the cylinder core in the opening direction of rotation is also released, however. In this regard, in such embodiments, ultimately, a torque may not be applied to the cylinder core in the opening direction of rotation and the latch element may not be moved into the release position at the same time so that any lock picking attempts may be effectively countered.

In some embodiments, the latch element deflection surface may be configured to slide along the blocking recess deflection surface upon application of the rotational force. Due to this sliding, the deflection of the rotational force may in particular take place so that the latch element may be displaceable radially outwardly so-to-say running onto the blocking recess deflection surface, and sliding along it with the latch element deflection surface, when a rotational force is applied to the cylinder core with the latch element positioned in the blocking position.

In some embodiments, the latch element deflection surface and the blocking recess deflection surface may be aligned parallel to one another when the latch element deflection surface is in contact with the blocking recess deflection surface. This may in particular enable an areal sliding of the latch element deflection surface along the blocking recess deflection surface and/or an areal contact of the latch element deflection surface with the blocking recess deflection surface to be able to urge the latch element uniformly radially outwardly and/or to be able to reliably secure it against a movement out of the blocking recess.

In some embodiments, the latch element deflection surface may extend from a radially inwardly disposed marginal section to a radially outwardly disposed marginal section, wherein the radially outwardly disposed marginal section may be arranged further in the opening direction of rotation than the radially inwardly disposed marginal section. Alternatively or additionally, the blocking recess deflection surface may extend from a radially inwardly disposed blocking recess inlet to a radially outwardly disposed blocking recess base, wherein the blocking recess deflection surface may be arranged further in the opening direction of rotation at the blocking recess base than at the blocking recess inlet.

In other words, in such embodiments, the latch element deflection surface may in particular be oriented tilted to the front in the opening direction of rotation, whereas the blocking recess deflection surface may in particular be designed as rising radially outwardly in a wedge-like manner in the opening direction of rotation. Due to such an orientation, the desired deflection of the rotational force (oriented tangentially to a rotational movement of the cylinder core) into a radially outwardly facing force may therefore be achieved.

In some embodiments, the latch element may have a respective latch element deflection surface both facing in the opening direction of rotation and facing in a direction of rotation opposite the opening direction of rotation.

In particular, this may enable a flexible use of the latch element and the cylinder core both in cylinder locks to be unlocked clockwise and in cylinder locks to be unlocked counterclockwise since the latch element has a respective latch element deflection surface for both possible opening directions of rotation to be able to cooperate with an associated blocking recess deflection surface of the cylinder housing and to be able to achieve the desired protection against a lock picking.

In the embodiments, the core housing may have a latch receiver into which the latch element may be inserted along an insertion direction oriented transversely, in particular perpendicular, to the cylinder axis. This may in particular enable a simple assembly of the latch element at the cylinder core in that the latch element may be inserted from a lateral direction and at an outer side of the cylinder core without having to be introduced into an inner space of the core housing, for instance, starting from an end face of the cylinder core. The latch element may then be secured in the latch receiver against a release opposite the insertion direction by introducing a fixing element into the latch receiver.

Furthermore, in some embodiments, the latch receiver may also form a blocking recess of the core housing, from which blocking recess the latch element may project in the blocking position to be able to engage into the blocking recess of the cylinder housing.

In some embodiments, the latch element may be movable linearly between the release position and the blocking position. In particular, the latch element may for this purpose be supported at the core housing by a preloading device, in particular a compression spring, and may be preloaded radially inwardly into the release position.

In some embodiments, the latch element may be pivotable between the release position and the blocking position. In such embodiments, the latch element may in particular have a blocking section that, in the blocking position, engages into the blocking recess of the cylinder housing and may be moveable out of the blocking recess by pivoting the latch element about a pivot axle, which may in particular be aligned parallel to the cylinder axis and/or oriented opposite the blocking section, in order to transfer the latch element into the release position.

In some embodiments, at the latch element, a pivot axle may be formed which extends parallel to the cylinder axis and about which the latch element may be pivoted. In particular, in some embodiments, the pivot axle may be formed in one part with the further sections of the latch element so that the latch element may directly have the pivot axle. However, in other embodiments, it may, for instance, also be provided that the pivot axle is originally formed as a separate component, for example a pin, and is fastened to the latch element, for example plugged in or screwed in. In particular, the pivot axle may, however, be mountable at the cylinder core in a joint assembly step with the further sections of the latch element and may, for instance, be insertable into the aforementioned latch receiver.

Furthermore, in some embodiments, the core housing may comprise an axle receiver which extends parallel to the cylinder axis and into which the pivot axle may be inserted along an insertion direction oriented transversely, in particular perpendicular, to the cylinder axis, wherein the pivot axle may be secured against a release from the axle receiver by a fixing element that may be inserted into the axle receiver, in particular may be clipped into the axle receiver.

In particular, the axle receiver may adjoin the aforementioned latch receiver (along the cylinder axis) and there may be a connection between the latch receiver and the axle receiver, by which connection the pivot axle arranged at the latch element may be able to be guided out of the latch receiver into the axle receiver. Therefore, in some embodiments, the latch receiver and the axle receiver may form a common latch element receiver. The insertion direction for inserting the pivot axle into the axle receiver may thus in particular correspond to the aforementioned insertion direction for inserting the latch element into the latch receiver.

Such an axle receiver may in particular enable a simple assembly of the cylinder core, and thus of the cylinder lock, in that the pivotable latch element may first be conveniently inserted into the latch receiver from a lateral direction along the insertion direction at an outer side of the cylinder core in order to secure the pivoting axle, and thus the latch element, at the cylinder core by inserting the fixing element. In this respect, a fixing element that may be clipped in may in particular enable an attachment of the latch element to the cylinder core without tools.

In some embodiments, a torsion spring may be arranged surrounding the pivot axle, by which torsion spring the latch element may be preloaded into the release position. In particular, the latch element may have a preloading section which engages around the torsion spring and at which a first leg of the torsion spring is supported, wherein a second leg of the torsion spring may be supported at the core housing.

Furthermore, in some embodiments, the pivot axle, with a torsion spring arranged thereat, may be introducible into the aforementioned axle receiver. This, too, may facilitate the assembly of the cylinder core since the torsion spring may be able to be conveniently guided outside the cylinder core via the pivot axle to then be able to be attached to the cylinder core in a joint assembly step with the latch element (and its pivot axle).

In some embodiments, the latch element may have a pin receiver at an end opposite the pivot axle and the core housing may have a housing pin receiver facing the pin receiver. Furthermore, a pin extending along the pivot axle may be inserted into the pin receiver and the housing pin receiver and the latch element may be pivotably supported about the pin.

The latch element may thus be supported opposite the pivot axle by the pin, wherein the pin may in particular extend along the pivot axle and may thus so-to-say continue the pivot axle. Furthermore, a connection between the latch element and the core housing may be established by the pin in order to secure the latch element against a release from the core housing and in particular against a release from the aforementioned latch receiver.

In some embodiments, the housing pin receiver may be formed as a continuous passage at an end face of a base body of the core housing and the core housing may in particular have a cover by which the housing pin receiver may be closeable at a side facing away from the pin.

The housing pin receiver may further in particular be formed at a housing recess of the core housing, into which housing recess the cover may be inserted.

Since the housing pin receiver may be formed as a continuous passage at an end face of a base body of the core housing, the pin may, starting from the end face of the base body of the core housing, in particular be introduced parallel to the cylinder axis through the housing pin receiver and into the pin receiver of the latch element. With regard to the assembly of the cylinder core, the latch element may therefore in particular first have to be inserted into the latch receiver from the lateral direction, whereupon the pin may be introduced parallel to the cylinder axis through the housing pin receiver and into the pin receiver of the latch element in order to reliably support the latch element at the core housing. The housing pin receiver and thus the passage may then be closed at the end face of the base body of the core housing by attaching the cover. Furthermore (before or after the introduction of the pin through the housing pin receiver), the latch element may be secured at the pivot axle by the aforementioned fixing element, wherein the assembly of the latch element at the cylinder core may thus in particular take place completely without tools.

Furthermore, a top cover may also be provided that may be fitted over the cover. The top cover may, for example, have a key introduction opening as the entrance of a keyway. In addition, the top cover may, for example, be formed in one part or two parts and/or the cover may serve to secure the cover in the aforementioned housing recess. The top cover may be able to be clipped onto the base body of the core housing.

In some embodiments, the disk tumblers may have a respective latch receiving recess and the latch element may have an engagement section that may engage into the latch receiving recesses when the disk tumblers are positioned in the unlocking position. The latch element may further assume the release position when the engagement section engages into the latch receiving recesses. When the disk tumblers are arranged in the unlocking position, the latch receiving recesses may in particular be arranged along the cylinder axis or parallel thereto and may form a latch receiving passage into which the engagement section engages.

In such embodiments, the latch receiving recesses may thus provide a free space which the latch element may enter when disk tumblers are positioned in the unlocking position to be able to move out of the blocking recess radially inwardly into the release position. If, on the other hand, at least one of the disk tumblers is not arranged in the unlocking position, the engagement section cannot enter into the respective latch receiving recess of the disk tumbler and is therefore blocked by this disk tumbler against a movement into the release position and thus in the blocking recess.

In some embodiments, the latch element may be pivotable between the release position and the blocking position and the engagement section may be formed by an end section of the latch element that is opposite a pivot axle of the latch element. In particular, by pivoting the latch element, the engagement section may therefore at least proportionally be movable radially and/or laterally away from the cylinder axis so that the latch element may engage into the blocking recess when the engagement section is urged outwards.

The disk tumblers may have respective locking sections adjoining the latch receiving recesses, wherein the latch element may contact the respective locking section of a disk tumbler arranged in the locking position and may thereby be urged into the blocking position, wherein the movement of the latch element into the release position may be blocked by the contact with the respective locking section. In particular, the latch receiving recesses may therefore form recesses with respect to the locking sections.

In some embodiments, the disk tumblers may have two respective latch receiving recesses that may be arranged symmetrically at the disk tumblers with respect to the cylinder axis. Alternatively thereto, the latch receiving recesses may be arranged centrally at the disk tumblers.

In particular, the disk tumblers may thus be designed symmetrically to the cylinder axis with respect to the latch receiving recesses. It may hereby be achieved that the disk tumblers may also be used regardless of a clockwise or counterclockwise orientation of the opening direction of rotation since a respective latch receiving recess, with which the latch element may cooperate, is present regardless of the orientation of the latch element. For example, in the case of a pivotably designed latch element, two mutually offset latch receiving recesses may therefore be provided, whereas, in the case of a linearly movable latch element, in particular a respective centrally designed latch receiving recess may be provided at the disk tumblers, into which latch receiving recess the latch element may engage independently of the provided opening direction of rotation when the disk tumblers assume the unlocking position.

The disk tumblers may be preloaded radially outwardly into the locking position and/or consecutively arranged disk tumblers may be preloaded radially outwardly in opposite directions into the respective locking position.

In some embodiments, the cylinder housing may have at least one disk tumbler blocking recess, in particular two mutually opposite disk tumbler blocking recesses, wherein, in the locking position, the disk tumblers may project out of the core housing and may engage into the at least one disk tumbler blocking recess, in particular a respective one of the two disk tumbler blocking recesses. Furthermore, in the unlocking position, the disk tumblers may be moved out of the at least one disk tumbler blocking recess, in particular out of the two disk tumbler blocking recesses.

In such embodiments, in the locking position, the disk tumblers may thus not only block the latch element in the blocking position, but may also directly block a rotation of the cylinder core into the open position in that the disk tumblers also abut boundaries of the respective disk tumbler blocking recess in the course of such a rotation. In particular, two disk tumbler blocking recesses arranged opposite one another may be provided in embodiments in which the disk tumblers are mutually oppositely preloaded into respective locking positions such that consecutively arranged disk tumblers may project out of the core housing at mutually opposite sides when the disk tumblers assume the locking position. On the other hand, it is generally also conceivable that the disk tumblers are preloaded radially outwardly in a common direction in order to all engage into a common disk tumbler blocking recess.

Furthermore, in such embodiments, it may be provided that the blocking element is secured in the blocking position by the deflection device and/or is urged further radially outwardly into the aforementioned decoupling position when the disk tumblers contact a boundary of the respective disk tumbler blocking recess in the opening direction of rotation. Thus, when the disk tumblers may generally be supported at edges of the disk tumbler blocking recess for the setting of the disk tumblers, it may in particular be ensured by the deflection device that the latch element may not be urged out of the blocking recess.

Furthermore, in some embodiments, it may also be provided that the disk tumblers do not project laterally beyond the core housing either in the unlocking position or in the locking position. In such embodiments, the disk tumblers may therefore be used exclusively to block the latch element in the blocking position or to release the latch element for the release position, whereas the disk tumblers, however, do not block a rotation of the cylinder core directly by a mechanical contact with the cylinder housing when the disk tumblers assume the locking position. Rather, in such embodiments, this direct mechanical blocking takes place exclusively by the latch element engaging into the blocking recess so that, at the cylinder housing, only one blocking recess has to be formed as well. This may increase the compatibility of the cylinder core with different types of cylinder housings since the cylinder core may thus also be used with those cylinder housings which only provide one or two blocking recesses, whereas at least three blocking recesses are required for disk tumblers that project out of the core housing oppositely to one another in the locking position.

In some embodiments, the cylinder lock may comprise the associated key that may in particular be configured as a reversible key.

### BRIEF DESCRIPTION OF THE DRAWINGS

The invention will be described in the following purely by way of example with reference to embodiment examples and to the drawings.

### In the drawings

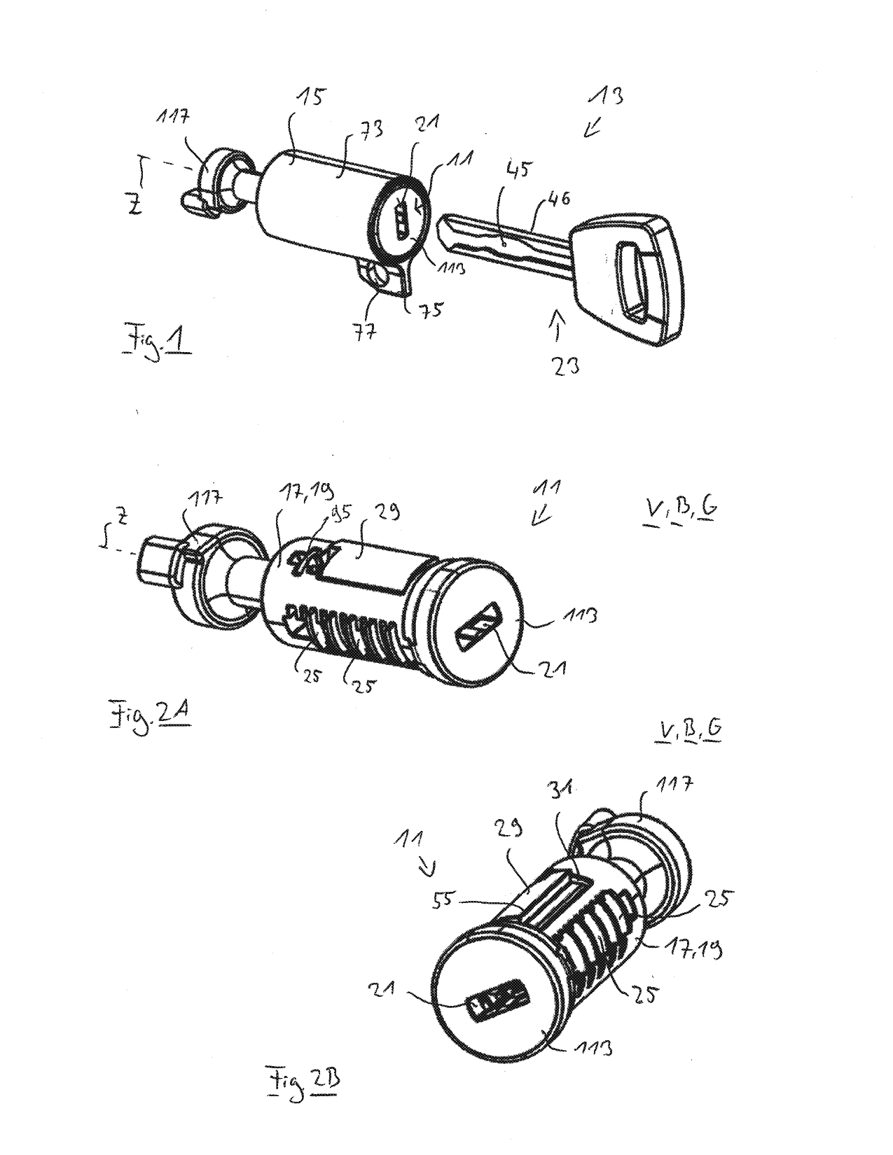

FIG. 1 is a perspective view of a cylinder lock with a cylinder housing and a cylinder core inserted therein as well as an associated key by way of which the cylinder core may be rotated relative to the cylinder housing;

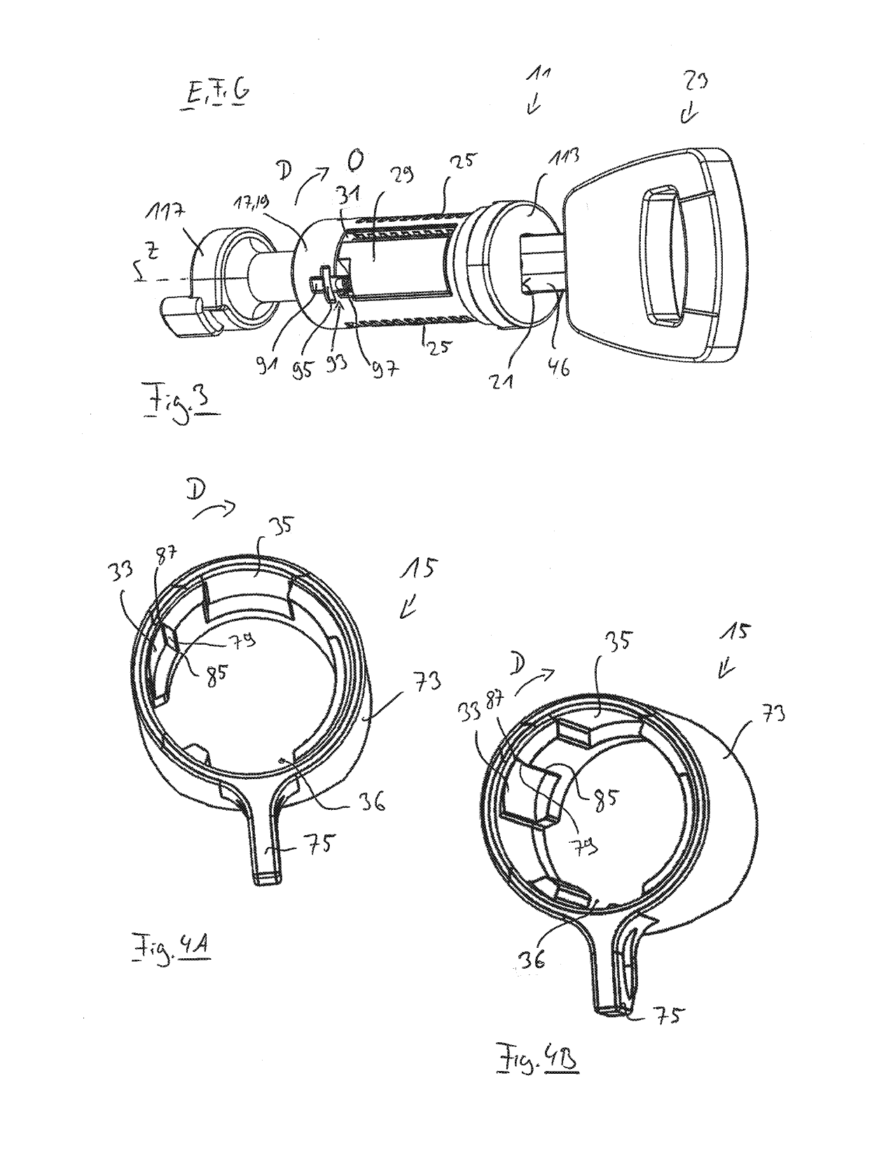

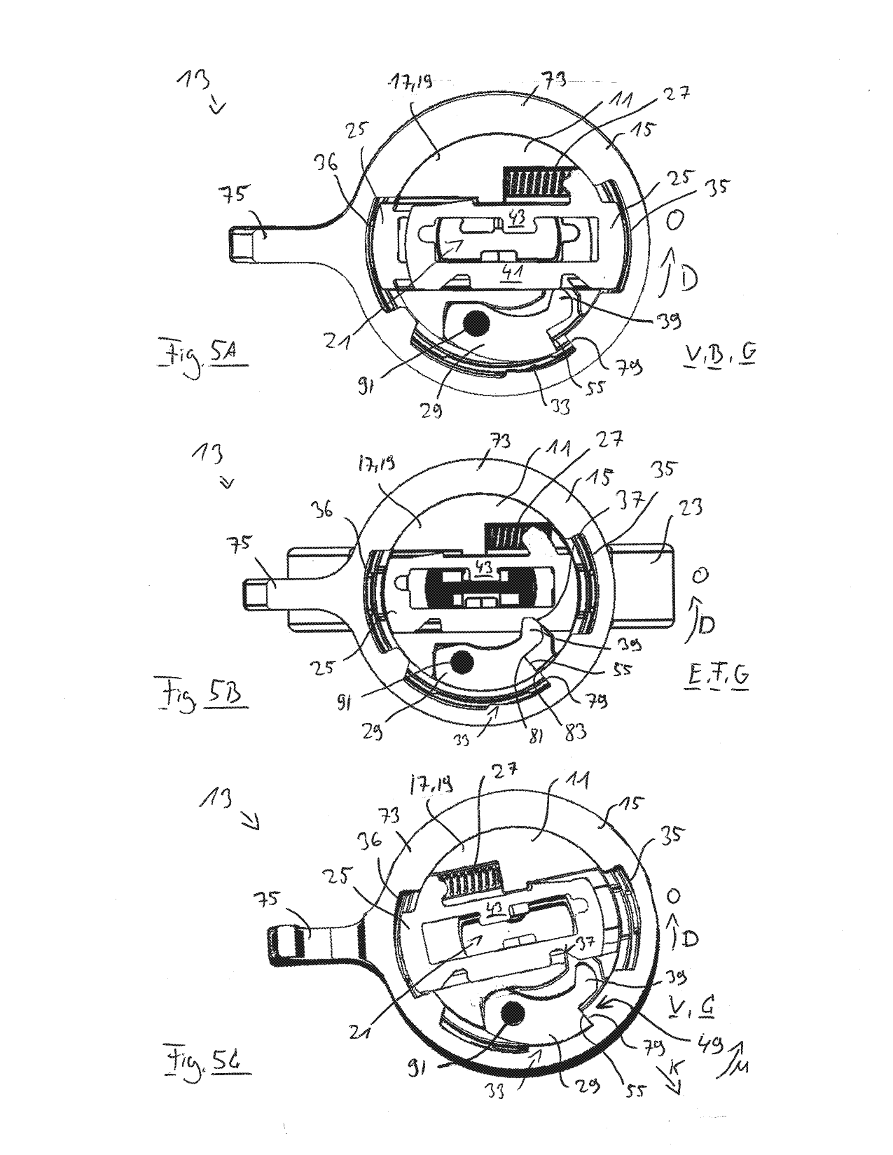

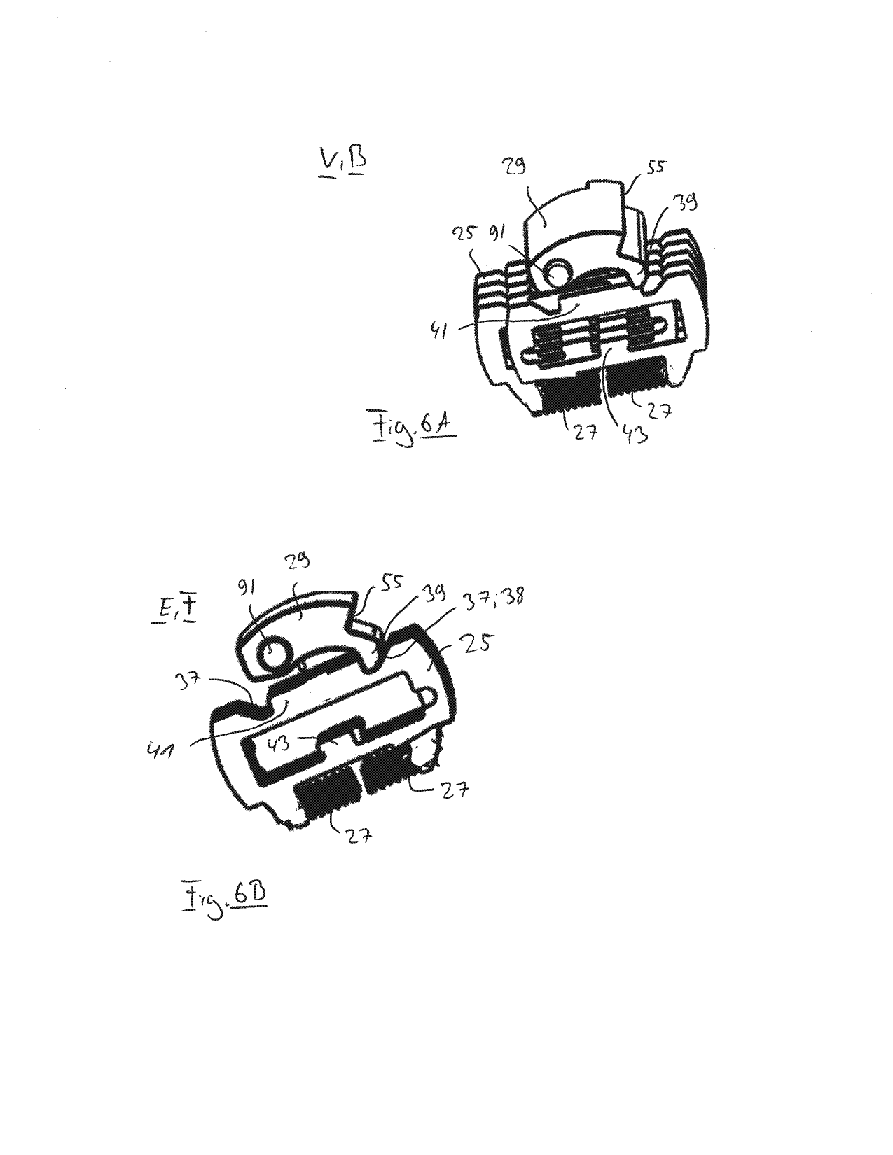

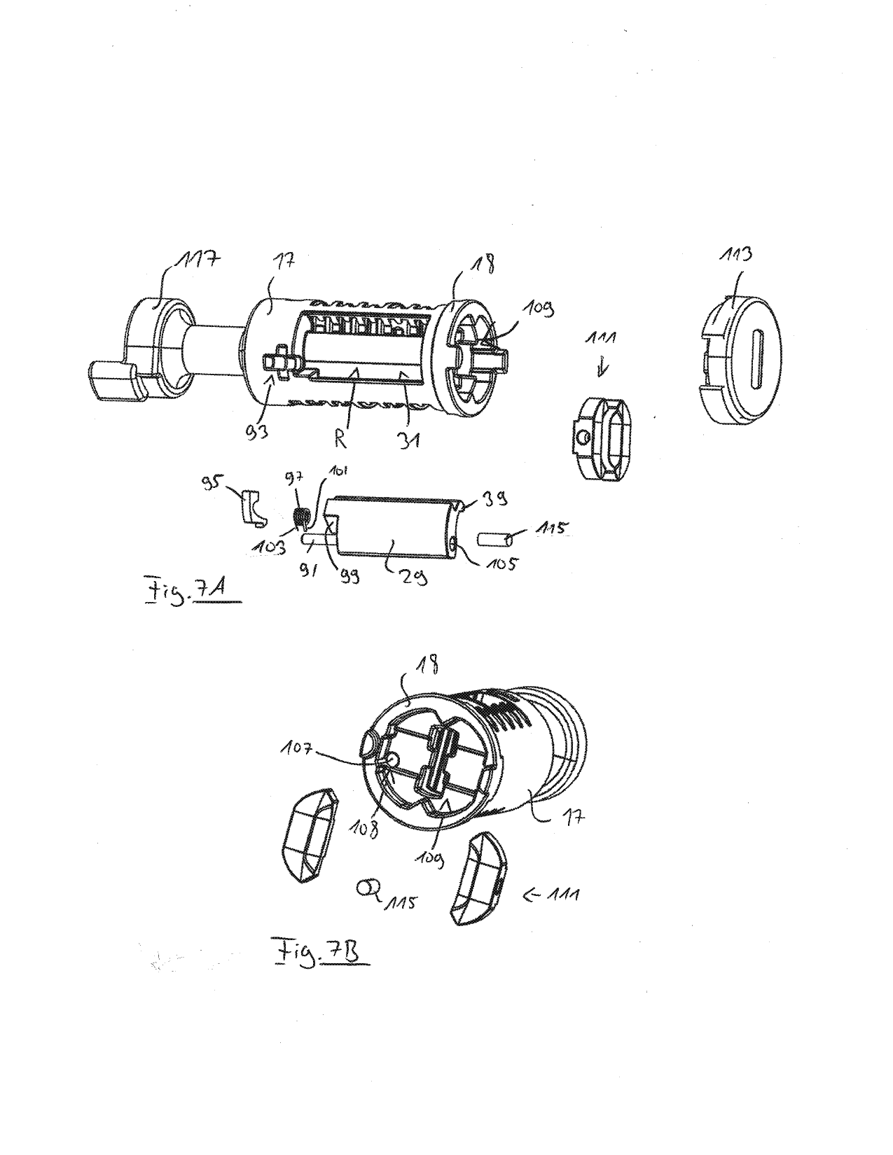

FIGS. 2A and 2B are a respective perspective representation of the cylinder core with the associated key not introduced;

FIG. 3 is a perspective representation of the cylinder core with the key introduced;

FIGS. 4A and 4B are a respective perspective representation of the cylinder housing;

FIGS. 5A-5C are a respective cross-sectional representation of the cylinder lock with the key not introduced into the cylinder core, with the associated key introduced and after a rotation of the cylinder core in an opening direction of rotation that took place in the course of a manipulation attempt with the key not introduced;

FIGS. 6A and 6B are a respective perspective representation of a latch element cooperating with disk tumblers of the cylinder core with the disk tumblers arranged in a locking position or with the disk tumblers arranged in an unlocking position;

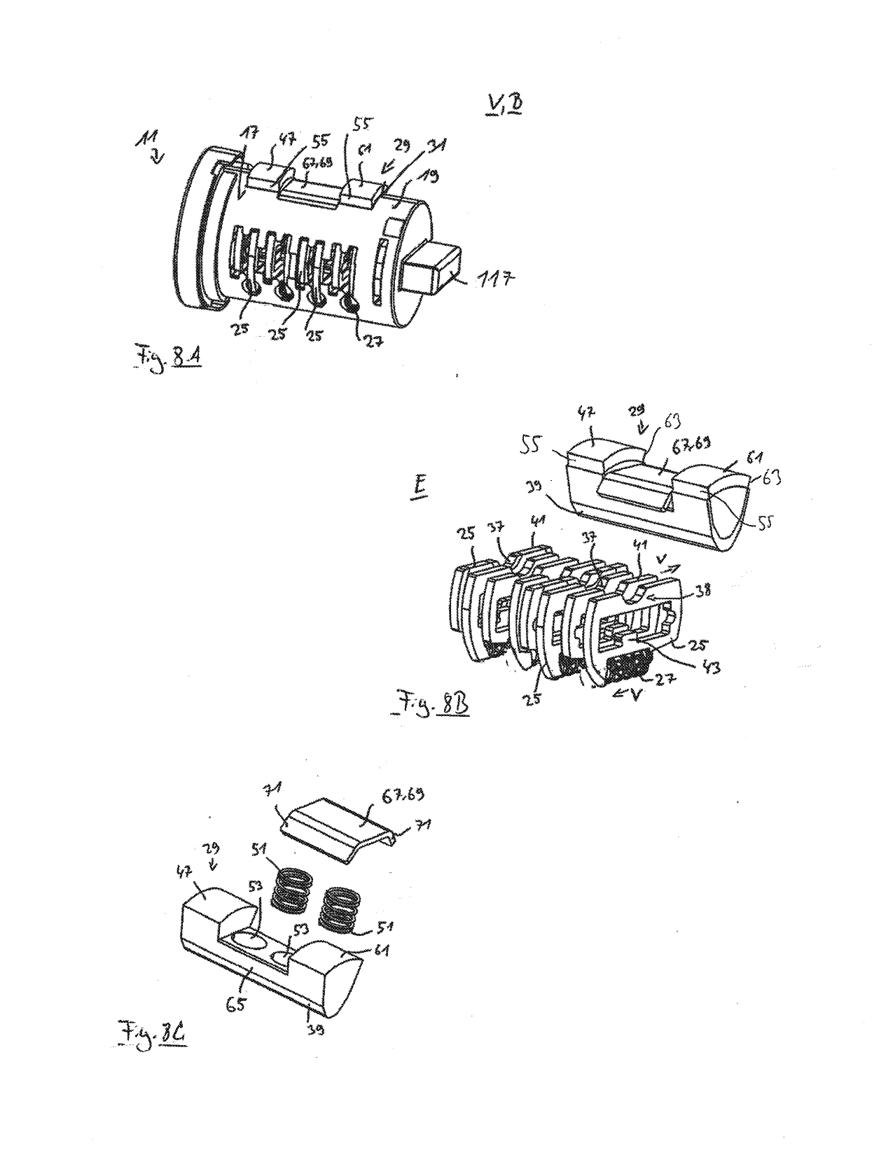

FIGS. 7A and 7B are an exploded representation and a front end view of the cylinder core; and

FIGS. 8A-8C are respective representations for illustrating a cylinder core and a latch element of a further embodiment.

### DETAILED DESCRIPTION

FIG. 1 shows a perspective representation of a cylinder lock 13 that has a cylinder housing 15 having a cylindrical core receiving section 73 in which a cylinder core 11 is inserted in a rotatably supported manner. The cylinder core 11 extends along a cylinder axis Z and has a keyway 21 which likewise extends along the cylinder axis Z and into which a key shaft 46 of an associated key 23 may be introduced to be able to rotate the cylinder core 11 relative to the cylinder housing 15 between a closed position G and an open position O (cf. also FIG. 3). To be able to rotate the cylinder core 11, a sorting structure 45 is provided at the key shaft 46 of the associated key 23, which is configured as a reversible key, and cooperates with disk tumblers 25 arranged in the cylinder core 11 in order to sort the disk tumblers 25 into a respective unlocking position E in which a rotation of the cylinder core 11, starting from the closed position G, along an opening direction of rotation D into the open position O is enabled. This is explained in more detail below.

In addition to the core receiving section 73, the cylinder housing 15 further has a flange section 75, which extends radially away from the core receiving section 73 with respect to the cylinder axis Z and which has an opening 77, so that the cylinder housing 15 may be secured against a rotation together with the cylinder core 11. A drive section 117 is axially coupled to the cylinder core 11 with respect to the cylinder axis Z in a rotationally effective manner to be able to transmit a rotation of the cylinder core 11 to the drive section 117 and, as a result, to be able to drive a latch, for example.

The configuration of the cylinder core 11 and the manner of the locking and unlocking can in particular largely be seen from FIGS. 2A to 4B.

FIGS. 2A and 2B illustrate the cylinder core 11 when the key 23 is not introduced, wherein it can be seen that, in this state of the cylinder core 11, the already mentioned disk tumblers 25 assume a locking position V and project laterally or radially with respect to the cylinder axis Z out of a cylindrical core housing section 19 of a core housing 17 of the cylinder core 11. Furthermore, a latch element 29 is inserted into a latch receiver 31 of the core housing 17 and, when the disk tumblers 25 are arranged in the locking position V, assumes a blocking position B in which the latch element 29 likewise projects laterally or radially beyond the core housing section 19.

FIG. 3, on the other hand, illustrates that the disk tumblers 25 may be moved from the locking position V into an unlocking position E, in which the disk tumblers 25 are arranged within the core housing 17, by introducing the key 23 into the keyway 21. In addition, when the key 23 is introduced and the disk tumblers 25 assume the unlocking position E, the latch element 29 is also moved radially inwardly into a release position F so that no components of the cylinder core 11 project radially out of the core housing section 19.

The manner of the locking of the cylinder lock 13 and the blocking of the cylinder core 11 against a rotation from the open position O into the closed position G can further be seen from the joint review of FIGS. 2A and 2B with FIGS. 4A and 4B. FIGS. 4A and 4B illustrate the cylinder housing 15 at which two mutually opposite disk tumbler blocking recesses 35 and 36 are formed, into which the disk tumblers 25 engage in the locking position V. Due to this engagement, in the locking position V, the disk tumblers 25 block a rotation of the cylinder core 11 along the opening direction of rotation D from the closed position G into the open position O so that the cylinder lock 13 is secured against an unauthorized opening.

Furthermore, at the cylinder housing 15, a blocking recess 33 is formed into which the latch element 29 engages in the blocking position B so that a rotation of the cylinder core 11 is also blocked by the latch element 29. Unlike the disk tumblers 25 that are formed comparatively narrow along the cylinder axis Z, during the attempt to forcibly rotate the cylinder core 11, the latch element 29 areally abuts a boundary of the blocking recess 33 in order to achieve a uniform force dissipation through this areal abutment and in particular to prevent a cutting into the cylinder housing 15, such as would be possible due to the narrowly formed disk tumblers 25, if necessary.

While the latch element 29 thus provides additional protection against a forced opening, a coding of the cylinder lock 13 for a securing against manipulation attempts, in which the associated key 23 is not used to open the cylinder lock 13, is achieved by the disk tumblers 25. In addition, in the locking position V, the disk tumblers 25 secure the latch element 29 in the blocking position B against a movement into the release position F in order, on the other hand, to release the latch element 29 in the unlocking position E for such a radially inward movement so that a movement of the latch element 29 into the release position F also requires the introduction of the associated key 23 into the keyway 21.

The cooperation between the latch element 29 and the disk tumblers 25 is in particular illustrated by way of FIGS. 6A and 6B, wherein, in the illustrated embodiment, the latch element 29 is pivotable about a pivot axle 91 between the blocking position B and the release position F and is preloaded into the release position F by a torsion spring 103 (cf. in particular also FIG. 7A). Furthermore, the disk tumblers 25 are preloaded into the locking position V by springs 27, wherein consecutively arranged disk tumblers 25 are, however, preloaded radially outwardly in opposite directions to one another to be able to engage into the two mutually oppositely arranged disk tumbler blocking recesses 35 and 36 of the cylinder housing 15.

As FIG. 6A shows, an engagement section 39 of the latch element 29 contacts locking sections 41 of the disk tumblers 25 when the disk tumblers 25 assume the locking position V so that the latch element 29 cannot pivot into the release position F, but is blocked in the blocking position B. However, the disk tumblers 25 have respective sorting sections 43 that extend into the keyway 21 to cooperate with the sorting structure 45 of the key 23 (cf. also FIGS. 5A-5C). By introducing the key 23, the disk tumbler 25 may therefore be moved against the preload into the locking position V into the unlocking position E illustrated in FIG. 6B and out of the disk tumbler blocking recesses 35 and 36.

Furthermore, in the unlocking position E, respective latch receiving recesses 37 formed at the disk tumblers 25 are arranged behind one another along the cylinder axis Z so that the engagement section 39 may engage into a latch receiving passage 38 formed by the latch receiving recesses 37 arranged in this way and the latch element 29 may pivot directly into the release position F due to the preload when all the disk tumblers 25 are sorted into the unlocking position E. After an introduction of the associated key 23 into the keyway 21, the cylinder core 11 may therefore be rotated directly into the open position O without further forces having to be applied to move the latch element 29 into the release position F.

Furthermore, FIG. 6B shows that the disk tumblers 25 have two respective latch receiving recesses 37 so that the disk tumblers 25 may, for instance, also cooperate with a latch element 29 that is arranged the other way round with respect to the representations in that the engagement section 39 could also engage into the latch receiving recesses 37 that remain free in FIG. 6B. This in particular makes it possible to use the disk tumblers 25 with cylinder locks 13 to be opened clockwise and counterclockwise by rotations of the cylinder core 11.

FIGS. 5A - 5C again illustrate the type of actuation of the cylinder lock 13, wherein it can furthermore be seen from FIG. 5C that the illustrated cylinder lock 13 offers extended protection against manipulation attempts on the basis of lock picking, as has also already been explained in the introductory part.

FIG. 5A shows the cylinder lock 13 with the cylinder core 11 positioned in the closed position G and the key 23 not introduced into the keyway 21, wherein the disk tumblers 25 assume the locking position V and engage into the disk tumbler blocking recesses 35 and 36. Furthermore, the engagement section 39 of the latch element 29 contacts the locking sections 41 of the disk tumblers 25 so that the latch element 29 engages into the blocking recess 33 and is blocked in the blocking position B.

FIG. 5B, on the other hand, illustrates that the disk tumblers 25 are sorted into the unlocking position E by introducing the associated key 23 into the keyway 21, whereupon the engagement section 39 of the latch element 29 engages into the latch receiving recesses 37 of the disk tumblers 25 and the latch element 29 pivots about the pivot axle 91 into the release position F. The cylinder core 11 is therefore released for a rotation relative to the cylinder housing 15 and may be rotated in the opening direction of rotation D into the open position O.

On the other hand, by way of FIG. 5C, an attempt is illustrated to rotate the cylinder core 11 in the direction of the open position O without introducing the associated key 21 in order to exert a torque on the cylinder core 11 in the opening direction of rotation D and to implement the methods of lock picking ("setting" or "probing") explained in the introduction.

Firstly, it can be seen from the joint review with FIG. 5A that the disk tumblers 25 and the latch element 29 are arranged with a rotational clearance in the respective blocking recess 33, 35 or 36 so that, even when the key 23 is not introduced, the cylinder core 11 may be rotated slightly in the opening direction of rotation D until the disk tumblers 25 and the latch element 29 abut boundaries of the respective blocking recess 33, 35 or 36 and thereby prevent the rotation of the cylinder core 11.

Furthermore, as FIG. 5C again shows, the cylinder lock 13, however, has a deflection device 49 that has a latch element deflection surface 55 formed at the latch element 29 and facing in the opening direction of rotation D and a blocking recess deflection surface 79 formed at the blocking recess 33 and facing the latch element deflection surface 55. In particular, the blocking recess deflection surface 79 forms a boundary of the blocking recess 33, which boundary the latch element deflection surface 55 abuts after overcoming the rotational clearance on a rotation in the opening direction of rotation D.

The latch element deflection surface 55 and the blocking recess deflection surface 79 are oriented inclined to the opening direction of rotation D and/or a radial direction with respect to the cylinder axis Z, wherein the latch element deflection surface 55 extends from a radially inwardly disposed marginal section 81 to a radially outwardly disposed marginal section 83, wherein the radially outwardly disposed marginal section 83 is arranged further in the opening direction of rotation D than the radially inwardly disposed marginal section 81. At the same time, the blocking recess deflection surface 79 extends from a blocking recess inlet 85 to a blocking recess base 87, wherein the blocking recess deflection surface 79 is arranged further in the opening direction of rotation D at the blocking recess base 87 than at the blocking recess inlet 85.

Therefore, the blocking recess deflection surface 79 so-to-say forms a wedge-like run-on surface for the latch element deflection surface 55, onto which the latch element deflection surface 55 runs in the course of the rotation of the cylinder core 11 in the opening direction of rotation. If a torque is thus applied to the cylinder core 11 in the opening direction of rotation D without the associated key 23 having been introduced into the keyway 21, the latch element deflection surface 55 comes into contact with the blocking recess deflection surface 79 and the rotational force M exerted on the latch element 29 in the opening direction of rotation D is deflected by the cooperation of the latch element deflection surface 55 and the blocking recess deflection surface 79 – and therefore by the deflection device 49 – into a radially outwardly acting force K with respect to the cylinder axis Z. Therefore, in the course of the overcoming of the aforementioned rotational clearance, the latch element 29 may be urged even further radially outwardly into a decoupling position C compared to the blocking position B and, as a result of the deflected rotational force M, pivots even further radially outwardly against the preload into the release position F (cf. FIG. 5C).

Due to this movement of the latch element 29, the engagement section 39 no longer contacts the locking sections 41 of the disk tumblers 25 in the decoupling position C, but is moved away from the disk tumblers 25 so that there is no longer any mechanical contact between the latch element 29 and the disk tumblers 25. Therefore, the respective unlocking position E of a disk tumbler 25 in particular cannot be deduced based on a contact with the latch element 29 through a changing resistance during a movement of the disk tumblers 25 so that the manipulation method of probing the coding may be counteracted. In addition, an attempt may indeed generally be made to sort the disk tumblers 25 one after another into the unlocking position E by the manipulation method of setting the disk tumblers 25 and to support them at edges of the respective disk tumbler blocking recess 35 or 36 against a movement back into the locking position V; however, even after such a potentially successful setting of the disk tumblers 25, the cylinder core 11 cannot be rotated further in the opening direction of rotation D than illustrated in FIG. 5C due to the still existing engagement of the latch element 29 into the blocking recesses 33. In addition, the latch element 29 in FIG. 5C is blocked against a radially inward movement by the blocking element deflection surface 79 and the cylinder core 11 must necessarily be rotated back into the closed position G in accordance with FIG. 5A, starting from the rotational position illustrated in FIG. 5C, so that the latch element 29 may move out of the blocking recess 33 at all. As a result of such a rotation, any support of the disk tumblers 25 at edges of the disk tumbler blocking recesses 35 and 36 would, however, be released so that the disk tumblers 25 may enter the locking position V again and the latch element 29 may again be transferred into the release position F solely by introducing the associated key 23. Any attempts to pick the cylinder lock 13 may therefore be effectively countered.

FIGS. 7A and 7B again illustrate the design of the cylinder core 11, and in particular of the core housing 17, wherein it can be seen that the latch element 29 may easily be inserted laterally along an insertion direction R into the latch receiver 31 already mentioned. The latch element 29 further has the pivot axle 91 about which the torsion spring 97 may be arranged before the insertion of the latch element 29 into the latch receiver 31 so that one leg 101 of the torsion spring 97 may be supported at a preloading section 99 of the latch element 29 and a further leg 103 of the torsion spring 97 may be supported at the core housing 17. Furthermore, the latch receiver 31 is adjoined by an axle receiver 93 into which the pivot axle 91 is introduced directly on the insertion of the latch element 29 into the latch receiver 31. In addition, a fixing element 95 is provided that may subsequently be inserted, likewise along the insertion direction R, into the axle receiver 93 and may in particular be clipped into it in order to secure the pivot axle 91, and thus the latch element 29, against a release from the axle receiver 93 or the latch receiver 31.

At a side opposite the pivot axle 91, the latch element 29 furthermore has a pin receiver 29, wherein, as in particular FIG. 7B shows, at an end face 109 of a base body 18 of the core housing 17, a mutually corresponding housing pin receiver 107 is formed as a continuous passage 108. This makes it possible to introduce a pin 115, starting from the end face 109 of the core housing 17, through the housing pin receiver 107 into the pin receiver 105 of the latch element 29 inserted into the latch receiver 31 in order to fix the latch element 29 to the core housing 17 and to support it at both sides. Furthermore, the housing pin receiver 107 is formed by way of example in a recess of the core housing 17, which recess may be closed by a two-part cover 111. In addition, a top cover 113 with an entrance for the keyway 21 may be plugged onto the base body 18 of the core housing 17. This configuration may enable a simple and in particular tool-free assembly of the latch element 29.

FIGS. 8A - 8C illustrate a further embodiment in which a latch element 29 is likewise provided that projects radially out of a core housing 17 in a blocking position B when the disk tumblers 25 are positioned in a locking position V. In this embodiment with two blocking sections 47 and 61, the latch element 29 projects out of the latch receiver 31 and may be moved linearly between the blocking position B and the release position F. As FIG. 8C illustrates, two spring receivers 53, which receive compression springs 51, are formed at a connection section 65, which connects the blocking sections 47 and 61 and which in turn also forms an engagement section 39, and a support section 67 formed as a support metal sheet 69 is arranged between the blocking sections 47 and 61 in the latch receiver 31 and is supported against a radially outward movement at the core housing 17 by folded edges 71. The springs 51 are radially outwardly supported at the support metal sheet 69 so that the latch element 29 is radially inwardly preloaded into the release position F by the springs 51. FIG. 8B further illustrates that, in this embodiment, disk tumblers 25 have a respective centrally arranged latch receiving recess 37, wherein, when the disk tumblers 25 are sorted into the unlocking position E, all the latch receiving recesses 37 are arranged behind one another along the cylinder axis Z and form a latch receiving passage 38 into which the aforementioned engagement section 39 of the latch element 29 may engage so that the latch element 29 may be moved into the release position F.

In addition, it can in particular be seen from FIG. 8B that, in this latch element 29, respective latch element deflection surfaces 55 are also provided to be able to cooperate in the manner explained above with respective blocking recess deflection surfaces, which are not specifically shown for this embodiment, and to be able to provide the explained protection against lock picking. Furthermore, at the latch element 29 of this embodiment, latch element deflection surfaces 63 are also arranged opposite the latch element deflection surfaces 55 so that the latch element 29 may in particular be used independently of an orientation of the opening direction of rotation D, i.e. both for cylinder locks to be opened clockwise and for cylinder locks to be opened counterclockwise, to be able to achieve the protection against lock picking through a cooperation with an associated blocking recess deflection surface.

### REFERENCE NUMERAL LIST

11 cylinder core
13 cylinder lock
15 cylinder housing
17 core housing
18 base body
19 core housing section
21 keyway
23 key
25 disk tumbler
27 spring
29 latch element
31 latch receiver
33 blocking recess
35 disk tumbler blocking recess
36 disk tumbler blocking recess
37 latch receiving recess
38 latch receiving passage
39 engagement section
41 locking section
43 sorting section
45 sorting structure
46 key shaft
47 blocking section
49 deflection device
51 spring
53 spring receiver
55 latch element deflection surface
61 blocking section
63 latch element deflection surface
65 connection section
67 support section
69 support metal sheet
71 folded edge
73 core receiving section
75 flange section
77 opening
79 blocking recess deflection surface
81 marginal section
83 marginal section
85 blocking recess inlet
87 blocking recess base
91 pivot axle
93 axle receiver
95 fixing element
97 torsion spring
99 preloading section
101 leg
103 leg
105 pin receiver
107 housing pin receiver
108 passage
109 end face
111 cover
113 top cover
115 pin
117 drive section
B blocking position
C decoupling position
D opening direction of rotation
E unlocking position
F release position
K force
M rotational force
G closed position
O open position
R insertion direction
V locking position
Z cylinder axis

What is claimed is:

1. A cylinder lock,
comprising a cylinder housing and a cylinder core extending along a cylinder axis,
wherein the cylinder core is rotatably received in the cylinder housing about the cylinder axis and can be rotated by an associated key along an opening direction of rotation from a closed position into an open position,
wherein the cylinder core has a core housing in which a plurality of disk tumblers and a latch element are received,
wherein the latch element is movable between a release position and a blocking position,
wherein, in the blocking position, the latch element projects radially out of the core housing with respect to the cylinder axis and engages into a blocking recess of the cylinder housing, wherein a rotation of the cylinder core from the closed position into the open position is blocked by the engagement of the latch element into the blocking recess, and
wherein, in the release position, the latch element is moved out of the blocking recess and releases the rotation of the cylinder core into the open position,
wherein the plurality of disk tumblers can be moved between a respective locking position and a respective unlocking position and are configured to block the latch element in the locking position against a movement into the release position and to release said latch element in the unlocking position for the movement into the release position,
wherein the latch element is preloaded into the release position, and wherein the cylinder lock further comprises a deflection device that is configured to deflect a rotational force that acts on the latch element, which assumes the blocking position, on a rotation of the cylinder core in the opening direction of rotation into a radially outwardly acting force.

2. A cylinder lock according to claim 1,
wherein the latch element can, starting from the blocking position, be urged further radially outwardly into a decoupling position by the deflection of the rotational force.

3. A cylinder lock according to claim 2,
wherein the latch element contacts the disk tumblers in the blocking position, and wherein the latch element is spaced apart from the disk tumblers in the decoupling position.

4. A cylinder lock according to claim 1,
wherein the latch element is arranged within the core housing in the release position.

5. A cylinder lock according to claim 1,
wherein the latch element has a latch element deflection surface facing in the opening direction of rotation and wherein the blocking recess has a blocking recess deflection surface facing the latch element deflection surface, wherein the rotational force can be deflected by a cooperation of the latch element deflection surface and the blocking recess deflection surface.

6. A cylinder lock according to claim 5,
wherein the latch element deflection surface and the blocking recess deflection surface are oriented inclined to the opening direction of rotation.

7. A cylinder lock according to claim 5,
wherein the latch element deflection surface is configured to slide along the blocking recess deflection surface upon application of the rotational force.

8. A cylinder lock according to claim 5,
wherein the latch element deflection surface and the blocking recess deflection surface are aligned parallel to one another when the latch element deflection surface is in contact with the blocking recess deflection surface.

9. A cylinder lock according to claim 5,
wherein the latch element deflection surface extends from a radially inwardly disposed marginal section to a radially outwardly disposed marginal section, wherein the radially outwardly disposed marginal section is arranged further in the opening direction of rotation than the radially inwardly disposed marginal section.

10. A cylinder lock according to claim 5,
wherein the blocking recess deflection surface extends from a radially inwardly disposed blocking recess inlet to a radially outwardly disposed blocking recess base, wherein the blocking recess deflection surface is arranged further in the opening direction of rotation at the blocking recess base than at the blocking recess inlet.

11. A cylinder lock according to claim 5,
wherein the latch element has a respective latch element deflection surface both facing in the opening direction of rotation and facing in a direction of rotation opposite the opening direction of rotation.

12. A cylinder lock according to claim 1,
wherein the core housing has a latch receiver into which the latch element can be inserted along an insertion direction oriented transversely to the cylinder axis.

13. A cylinder lock according to claim 1,
wherein the latch element can be moved linearly between the release position and the blocking position.

14. A cylinder lock according to claim 1,
wherein the latch element can be pivoted between the release position and the blocking position.

15. A cylinder lock according to claim 14,
wherein, at the latch element, a pivot axle is formed which extends parallel to the cylinder axis and about which the latch element can be pivoted.

16. A cylinder lock according to claim 15,
wherein the core housing comprises an axle receiver which extends parallel to the cylinder axis and into which the pivot axle can be inserted along an insertion direction oriented transversely to the cylinder axis, and wherein the pivot axle is secured against a release from the axle receiver by a fixing element that can be inserted into the axle receiver.

17. A cylinder lock according to claim 15,
wherein the latch element has a pin receiver at an end opposite the pivot axle and wherein the core housing has a housing pin receiver facing the pin receiver, wherein a pin extending along the pivot axle is inserted into the pin receiver and the housing pin receiver and wherein the latch element is pivotably supported about the pin.

18. A cylinder lock according to claim 17,
wherein the housing pin receiver is formed as a continuous passage at an end face of a base body of the core housing.

19. A cylinder lock according to claim 18,
wherein the core housing has a cover by which the housing pin receiver can be closed at a side facing away from the pin.

20. A cylinder lock according to claim 1,
wherein the cylinder housing has at least one disk tumbler blocking recess, wherein, in the locking position, the disk tumblers project out of the core housing and engage into the at least one disk tumbler blocking recess, wherein, in the unlocking position, the disk tumblers are moved out of the at least one disk tumbler blocking recess.
